(19) United States
(12) Patent Application Publication
(10) Pub. No.: US 2015/0116348 A1
(43) Pub. Date: Apr. 30, 2015

(54) METHOD AND DEVICE FOR PROCESSING WALLPAPER

(71) Applicants: Kai Wang, Shenzhen (CN); Zhisong Shu, Shenzhen (CN)

(72) Inventors: Kai Wang, Shenzhen (CN); Zhisong Shu, Shenzhen (CN)

(73) Assignee: ZTE Corporation, Shenzhen, Guangdong Province (CN)

(21) Appl. No.: 14/404,510

(22) PCT Filed: Jul. 13, 2012
(86) PCT No.: PCT/CN2012/078645

§ 371 Date: Nov. 28, 2014

(30) Foreign Application Priority Data
May 29, 2012 (CN) 201210171305.X

(51) Int. Cl. G06T 11/00

(52) U.S. Cl. CPC G06T 11/001; G06T 2215/16
USPC 345/619

(57) ABSTRACT

The disclosure provides a method and device for processing wallpaper. The method comprises: acquiring the position information of a mobile terminal; judging whether to replace wallpaper displayed by the mobile terminal with a content corresponding to preset position information or not according to the acquired position information and the preset position information; and displaying the content corresponding to the preset position information as the wallpaper based on that a judgment result is positive. By the disclosure, the problem of poor user experience when a user of the mobile terminal uses the wallpaper or a theme in the prior art is solved, and effects of automatically replacing the wallpaper and meeting diversified and personalized requirements of the user are further achieved.

### FIELD

The disclosure relates to the field of communication, including, e.g., a method and device for processing wallpaper.

### BACKGROUND

As a tool for daily life and business affairs, a mobile communication terminal is important in the life of a user. A wallpaper or theme selection function for the user are usually provided in a common mobile communication terminal, for example, the user can select a picture as a background picture of a mobile phone screen. The picture can be a picture that stored on a mobile phone of the user, and can also be a photo shot by the user as well as a picture downloaded when the user accesses a network of an operator. However, the conventional mobile terminal usually cannot provide the autonomous replacement of wallpaper or a theme for the user. After selecting the wallpaper or the theme, the user can only manually replace the wallpaper or the theme if getting bored with the wallpaper or the theme, so that the user experience is poor.

Therefore, the problem of poor user experience when the user of the mobile terminal uses the wallpaper or the theme exists in the related art.

### SUMMARY

A method and a device for processing wallpaper is provided in the embodiment of the disclosure, so as to at least solve the problem of poor user experience when a user of a mobile terminal uses wallpaper or a theme in the related art.

According to one aspect of the embodiment of the disclosure, a method for processing wallpaper is provided, comprising: acquiring the position information of a mobile terminal; judging whether to replace wallpaper displayed by the mobile terminal with a content corresponding to preset position information or not according to the acquired position information and the preset position information; and displaying the content corresponding to the preset position information as the wallpaper based on that a judgment result is positive.

According an embodiment of the disclosure, judging whether to replace the wallpaper displayed by the mobile terminal with the content corresponding to the preset position information or not according to the acquired position information and the preset position information comprises: acquiring a position coordinate of the mobile terminal and a position coordinate of the content corresponding to the preset position information according to the position information and the preset position information: judging whether a difference between the position coordinate of the mobile terminal and the position coordinate of the content corresponding to the preset position information is smaller than a preset threshold value or not; and determining to replace the wallpaper displayed by the mobile terminal with the content corresponding to the preset position information based on that a judgment result is positive.

According an embodiment of the disclosure, displaying the content corresponding to the preset position information as the wallpaper comprises: based on that the content corresponding to the preset position information is a photo shot by the mobile terminal, setting a mapping relationship between the shot photo and the acquired position information of the mobile terminal; and displaying the shot photo corresponding to the acquired position information of the mobile terminal as the wallpaper according to the mapping relationship.

According an embodiment of the disclosure, before acquiring the position information of the mobile terminal, further comprising: setting a preset time interval, and acquiring the position information of the mobile terminal based on that the preset time interval is reached.

According an embodiment of the disclosure the position information of the mobile terminal is acquired in at least one of the following manners: the position information of the mobile terminal is acquired in a Global Positioning System (GPS) positioning manner; the position information of the mobile terminal is acquired in a Glonass positioning system positioning manner; the position information of the mobile terminal is acquired in a Wireless Fidelity (Wi-Fi) hotspot positioning manner; and the position information of the mobile terminal is acquired in a mobile network cell positioning manner.

According an embodiment of the disclosure, the content corresponding to the preset position information comprises at least one of: a picture, an animation, an art text and a series theme.

According to the other aspect of the embodiment of the disclosure, a device for wallpaper processing is provided, comprising: a first acquiring component, configured to acquire the position information of a mobile terminal; a first judging component, configured to judge whether to replace wallpaper displayed by the mobile terminal with a content corresponding to preset position information or not according to the acquired position information and the preset position information; and a first displaying component, configured to display the content corresponding to the preset position information as the wallpaper based on that a judgment result is positive.

According an embodiment of the disclosure, the first judging component comprises: a second acquiring component, configured to acquire a position coordinate of the mobile terminal and a position coordinate of the content corresponding to the preset position information according to the position information and the preset position information; a second judging component, configured to judge whether a difference between the position coordinate of the mobile terminal and the position coordinate of the content corresponding to the preset position information is smaller than a preset threshold value or not; and a determining component, configured to determine to replace the wallpaper displayed by the mobile terminal with the content corresponding to the preset position information based on that a judgment result is positive.

According an embodiment of the disclosure, the first displaying component comprises: a first setting component, configured to, based on that the content corresponding to the preset position information is a photo shot by the mobile terminal, set a mapping relationship between the shot photo and the acquired position information of the mobile terminal; and a second displaying component, configured to display the shot photo corresponding to the acquired position information of the mobile terminal as the wallpaper according to the mapping relationship.

According an embodiment of the disclosure, further comprising: a second setting component, configured to, before the position information of the mobile terminal is acquired, set a preset time interval, and acquire the position information of the mobile terminal based on that the preset time interval is reached.

By the embodiment of the disclosure, the position information of the mobile terminal is acquired, whether to replace the wallpaper displayed by the mobile terminal with the content corresponding to the preset position information or not is judged according to the acquired position information and the preset position information; and based on that the display result is positive, the content corresponding to the preset position information is displayed as the wallpaper, so that the problem of poor user experience when the user of the mobile terminal uses the wallpaper or the theme in the related art is solved, and effects of automatically replacing the wallpaper and meeting diversified and personalized requirements of the user are further achieved.

### BRIEF DESCRIPTION OF THE DRAWINGS

The drawings are described here to provide further understanding of the disclosure, and form a part of the disclosure. The schematic embodiments and description of the disclosure are adopted to explain the disclosure, and do not form improper limits to the disclosure. In the drawings:

FIG. 1 is a flowchart of a method for processing wallpaper according to an embodiment of the disclosure;

FIG. 2 is a structure diagram of a device for processing wallpaper according to an embodiment of the disclosure;

FIG. 3 is a structure diagram of a first judging component 24 in a device for processing wallpaper according to an embodiment of the disclosure;

FIG. 4 is a structure diagram of a first displaying component 26 in a device for processing wallpaper according to an embodiment of the disclosure;

FIG. 5 is a structure diagram of a device for processing wallpaper according to a preferred embodiment of the disclosure;

FIG. 6 is a structure diagram of a mobile terminal according to an embodiment of the disclosure; and

FIG. 7 is a flowchart of a method for processing wallpaper according to an embodiment of the disclosure.

### DETAILED DESCRIPTION OF THE EMBODIMENTS

The disclosure is described below with reference to the drawings and embodiments in detail. It is important to note that the embodiments of the disclosure and the characteristics in the embodiments can be combined if there is no conflicts.

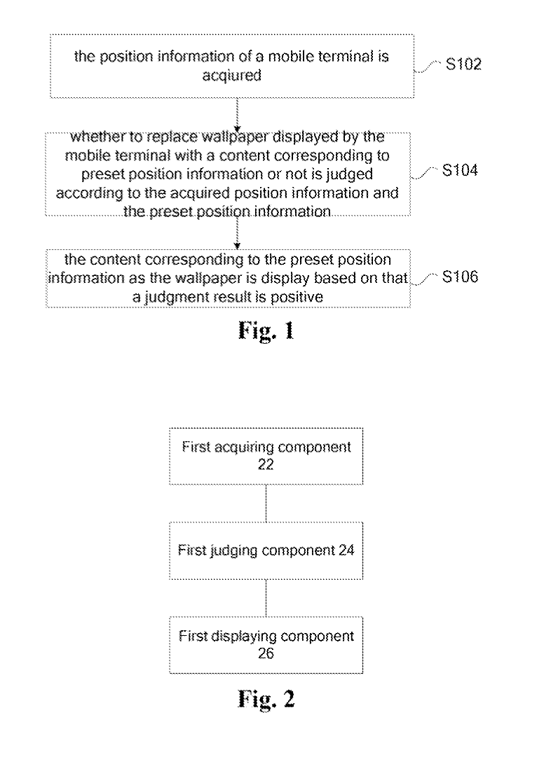

A method for processing wallpaper is provided in the embodiment, FIG. 1 is a flowchart of a method for processing wallpaper according to an embodiment of the disclosure, and as shown in FIG. 1, the flow comprises the following steps:

S102: the position information of a mobile terminal is acquired;

S104: whether to replace wallpaper displayed by the mobile terminal with a content corresponding to preset position information or not is judged according to the acquired position information and the preset position information, wherein the content corresponding to the preset position information can include at least one of a picture, an animation, an art text and a series theme (the series theme here refers to a series content oriented to a certain theme or a combination of a group of contents); and

S106: the content corresponding to the preset position information as the wallpaper is displayed based on that a judgment result is positive.

By the steps, the mobile terminal determines whether to replace the wallpaper of the mobile terminal or not by acquiring the position information of the mobile terminal; in contrast to the prior art, certain current wallpaper is required to be manually replaced when being not used, and when the diversity of the wallpaper needs to be presented, the operation is required to be repeated for many times; and by adopting the mobile terminal position information acquisition manner rather than the manual replacement manner in the related art for the replacement of the wallpaper, the problem of serious impact on a user experience is solved, the wallpaper of the mobile terminal can be automatically replaced, and diversified and personalized requirements of a user is met.

Judging whether to replace the wallpaper displayed by the mobile terminal with the content corresponding to the preset position information or not according to the acquired position information and the preset position information comprises: a position coordinate of the mobile terminal and a position coordinate of the content corresponding to the preset position information is acquired according to the position information and the preset position information; whether a difference between the position coordinate of the mobile terminal and the position coordinate of the content corresponding to the preset position information is smaller than a preset threshold value or not is judged: and it is determined to replace the wallpaper displayed by the mobile terminal with the content corresponding to the preset position information based on that a judgment result is positive. in such a processing manner, the threshold value can be set to be different values according to different positions of the mobile terminal, for example, the threshold value can be set to be greater when the position of the mobile terminal is in a wider area, and can be set to be smaller when the position of the mobile terminal is in a denser area, and the setting of the threshold value can be flexibly controlled according to a condition.

According to an embodiment of the disclosure, based on that the content corresponding to the preset position information is a photo shot by the mobile terminal, a mapping relationship between the shot photo and the acquired position information of the mobile terminal is set; and the shot photo corresponding to the acquired position information of the mobile terminal is displayed as the wallpaper according to the mapping relationship, that is, when taking the photo, the user of the mobile terminal can automatically map the shot photo and the acquired position information of the mobile terminal, and by such processing, a wallpaper replacement speed is increased.

According to different diversified and personalized requirements of the user, before the position information of the mobile terminal is acquired, a preset time interval is set, and based on that the preset time interval is reached, the position information of the mobile terminal is acquired, thereby replacing the wallpaper according to the position information of the mobile terminal. Preferably, there are many manners for acquiring the position information of the mobile terminal, for example, the position information of the mobile terminal can be acquired in at least one of the following manners: the position information of the mobile terminal is acquired in a GPS positioning manner; the position information of the mobile terminal is acquired in a Glonass positioning system positioning manner; the position information of the mobile terminal is acquired in a Wi-Fi hotspot positioning manner; and the position information of the mobile terminal is acquired in a mobile network cell positioning manner.

A device for processing wallpaper is also provide in the embodiment, which is configured to implement the embodiments and the preferred embodiments, and what has been described will not be repeated. For example, a term component, used below, is a combination of software and/or hardware capable of realizing preset functions. The device described in the following embodiments is preferably implemented by software, but the implementation of the device with hardware or the combination of software and hardware is also possible and conceived.

FIG. 2 is a structure diagram of a device for processing wallpaper according to an embodiment of the disclosure, and as shown in FIG. 2, the device comprises a first acquiring component 22, a first judging component 24 and a first displaying component 26. The device is described below.

The first acquiring component 22, is configured to acquire the position information of a mobile terminal; the first judging component 24, connected to the first acquiring component 22, is configured to judge whether to replace wallpaper displayed by the mobile terminal with a content corresponding to preset position information or not according to the acquired position information and the preset position information: and the first displaying component 26, connected to the first judging component 24, is configured to display the content corresponding to the preset position information as the wallpaper based on that a judgment result is positive.

FIG. 3 is a structure diagram of a first judging component 24 in a device for processing wallpaper according to an embodiment of the disclosure, and as shown in FIG. 3, the first judging component 24 comprises a second acquiring component 32, a second judging component 34 and a determining component 36. The first judging component 24 is described below.

The second acquiring component 32, is configured to acquire a position coordinate of the mobile terminal and a position coordinate of the content corresponding to the preset position information according to the position information and the preset position information; the second judging component 34, connected to the second acquiring component 32, is configured to judge whether a difference between the position coordinate of the mobile terminal and the position coordinate of the content corresponding to the preset position information is smaller than a preset threshold value or not; and the determining component 36, connected to the second judging component 34, is configured to determine to replace the wallpaper displayed by the mobile terminal with the content corresponding to the preset position information based on that a judgment result is positive.

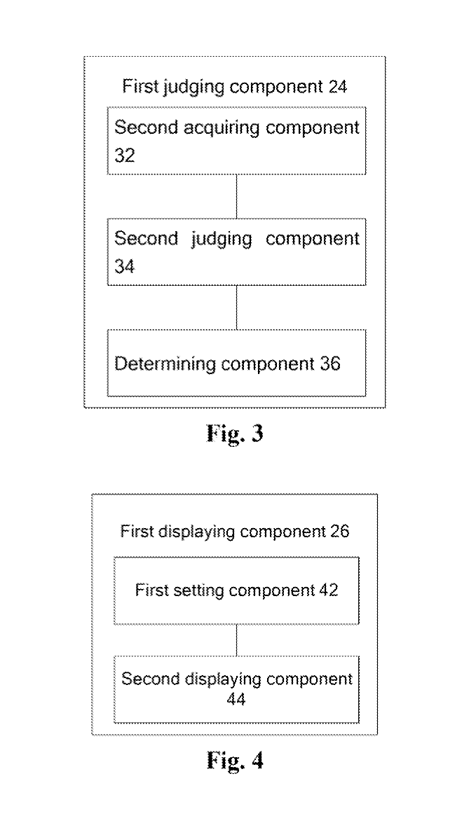

FIG. 4 is a structure diagram of a first displaying component 26 in a device for processing wallpaper according to an embodiment of the disclosure, and as shown in FIG. 4, the first displaying component 26 comprises a first setting component 42 and a second displaying component 44. The device is described below.

The first setting component 42, is configured to, based on that the content corresponding to the preset position information is a photo shot by the mobile terminal, set a mapping relationship between the shot photo and the acquired position information of the mobile terminal; and the second displaying component 44, connected to the first setting component 42, is configured to display the shot photo corresponding to the acquired position information of the mobile terminal as the wallpaper according to the mapping relationship.

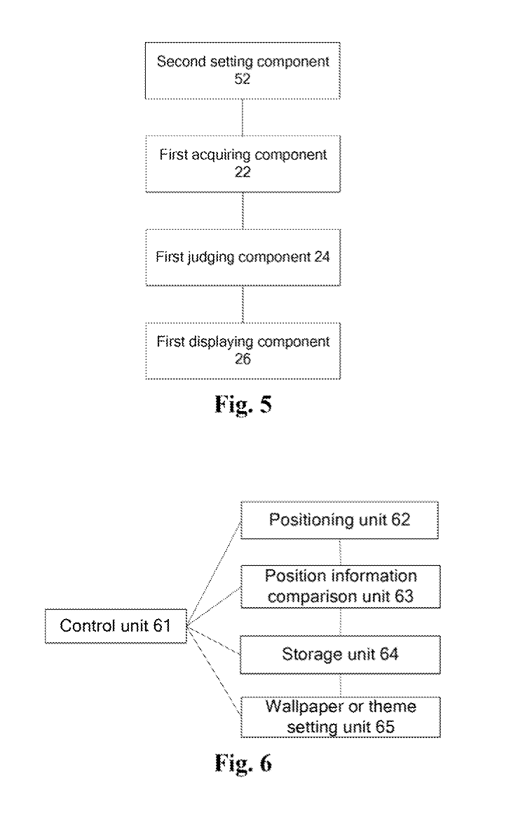

FIG. 5 is a structure diagram of a device for processing wallpaper according to a preferred embodiment of the disclosure, and as shown in FIG. 5, the device further comprises a second setting component 52, besides all the components shown in FIG. 2, wherein the second setting component 52 is configured to, before the position information of the mobile terminal is acquired, set a preset time interval, and acquire the position information of the mobile terminal based on that the preset time interval is reached.

A GPS is a system for performing global positioning and navigation in real time by virtue of a GPS positioning satellite. The GPS is applied to mobile terminals in a large scale, and almost becomes a standard configuration of a mobile communication terminal such as a mobile phone. The GPS belongs to a popular positioning system, and other positioning systems further comprised a Glonass positioning system, a Wi-Fi hotspot positioning system, a mobile network cell positioning system and the like.

According to the embodiment of the disclosure, by combining the property that a positioning system can position a mobile terminal and a function of the mobile terminal for providing many kinds of wallpaper or themes, a method and system for automatically replacing the wallpaper or theme of the mobile terminal are provided. FIG. 6 is a structure diagram of a mobile terminal according to an embodiment of the disclosure, and as shown in FIG. 6, the mobile terminal employing the method and the system comprises a control unit 61 (configured to realize control between every two components), a positioning unit 62 (configured to realize a function of the acquiring component), a position information comparison unit 63 (configured to realize a function of the judging component), a storage unit 64 and a wallpaper or theme setting unit 65 (configured to realize a function of the displaying component). The positioning unit realizes the acquisition of position information of the mobile terminal, the position information comparison unit realizes the comparison of the position information, the storage unit realizes the storage of the wallpaper or the themes, the wallpaper or theme setting unit finishes the setting of the wallpaper or the themes, and the units are combined to finish the automatic replacement of the wallpaper or theme of the terminal.

The method and system for automatically replacing the wallpaper or theme of the mobile terminal is provided by the embodiment of the disclosure. Based on a GPS and the like of the mobile terminal, the mobile terminal employing the method and the system possess a terminal position information acquiring capability, a position information comparing and judging capability and a wallpaper or theme setting capability. The capabilities of the mobile terminal are implemented by the control unit, the positioning unit, the position information comparison unit, the storage unit and the wallpaper or theme setting unit in the mobile terminal respectively. Description is given below with reference to the functions realized by each function unit respectively.

The above control unit in the mobile terminal can be a subsystem or a component with a function similar to that of an application processor, a baseband processor and the like. The control unit is configured to periodically control the positioning unit according to a preset time interval; the positioning unit is configured to finish the acquisition of the position information of the mobile terminal according to the control of the control unit; the control unit also transmits the position information acquired by the positioning unit to the position information comparison unit; and the position information comparison unit judges whether the wallpaper or the theme is required to be replaced or not according to the received position information, and outputs a judgment result. The above control unit also receives the judgment result output by the position information comparison unit, and performs subsequent operation according to the judgment result. For example: if the judgment result indicates that the wallpaper or the theme is required to be replaced, the control unit reads wallpaper or a theme from the storage unit, and outputs the read wallpaper or theme to the wallpaper or theme setting unit, wherein the storage unit is configured to store the wallpaper or the themes, and the wallpaper or theme setting unit is configured to set the wallpaper or the theme, thereby finishing the replacement of the wallpaper or the theme. In addition, the control unit can also automatically map a shot photo and the position information acquired by the positioning unit when the user of the mobile terminal takes the photo by using a photographic unit. The positioning unit in the embodiment or the preferred embodiment can be a receiving unit based on the GPS or another positioning system such as a Glonass positioning system, a Wi-Fi hotspot positioning system and a mobile network cell positioning system. The positioning unit comprises a receiving antenna required by the positioning system, and is configured to receive a signal from the GPS and the like to acquire the position information of the mobile terminal.

Wherein the position information comparison unit is configured to compare an acquired position signal with a group of position signal data set in the comparison unit, judge an area coverage where the mobile terminal is located, judge whether the wallpaper or the theme is required to be replaced or not according to a preset judgment condition and output the judgment result to the control unit. The storage unit is configured to store various wallpaper or theme data. The wallpaper can be a locally stored picture, and can also be the photo shot by the user. The theme can be a group of locally stored pictures, and can also be a group of photos shot by the user in the vicinity of the same place. The wallpaper or theme setting unit is configured to replace the wallpaper or the theme according to the input data of the control unit. By the method for processing wallpaper or theme provided in the embodiment or the preferred embodiment, the wallpaper or the theme can be conveniently and automatically replaced, and information related to the position information of the mobile terminal can also be directly reflected (for example, a picture of a scenic spot in the vicinity of the position of the user can be used as the wallpaper), so that the diversified and personalized application requirements of the user are met.

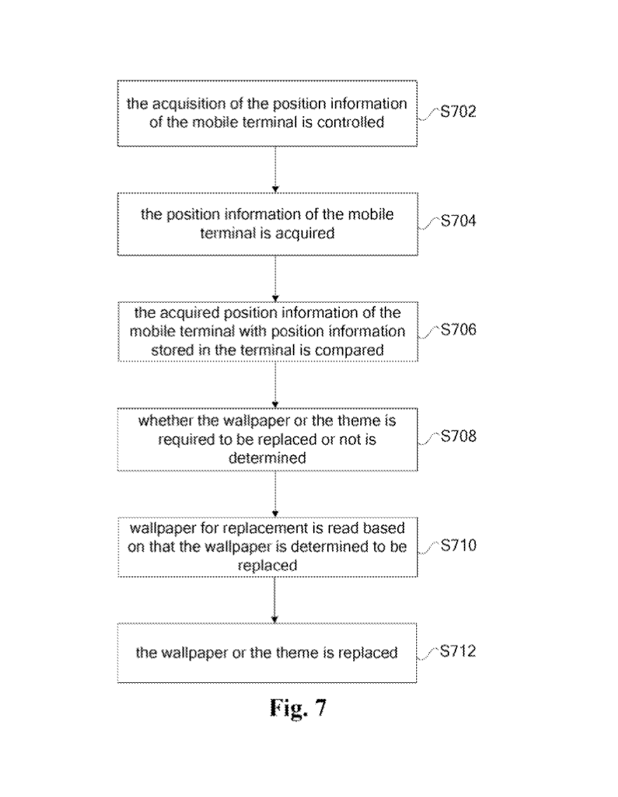

A method for processing wallpaper is provided in the preferred embodiment. In the preferred embodiment, description is given by taking the condition that a mobile terminal automatically uses a picture of a scenic spot in the vicinity of a place where a user is located as the wallpaper of the mobile terminal according to the position information of the user as an example. FIG. 7 is a flowchart of a method for processing wallpaper according to an embodiment of the disclosure, and as shown in FIG. 7, the method comprises the following steps that:

S702: the acquisition of position information of the mobile terminal is controlled, for example, a control unit of the mobile terminal periodically starts a positioning unit to acquire the position information of the mobile terminal according to a preset time interval;

S704: the position information of the mobile terminal is acquired, for example, the information from a GPS and the like is received by the positioning unit and the acquired position information of the mobile terminal is transmitted from the control unit to a position information comparison unit;

S706: the acquired position information of the mobile terminal is compared with position information stored in the terminal, wherein, during implementation, such a processing manner can be adopted: the position information comparison unit compares an acquired position signal with a group of position signal data (a group of position coordinates of various well-known scenic spots in the embodiment) set in the comparison unit, judges an area coverage where the mobile terminal is located, judges whether the wallpaper or a theme is required to be replaced or not according to a preset judgment condition (for example, a difference between the position coordinate of the mobile terminal and a position coordinate of a certain scenic spot is smaller than a threshold value) and outputs a judgment result to the control unit;

S708: whether the wallpaper or the theme is required to be replaced or not is judged, for example, the control unit determines whether the wallpaper is required to be replaced or not according to the judgment result output by the position information comparison unit;

S710: based on that the wallpaper is determined to be replaced, wallpaper for replacement is read, that is, the control unit reads wallpaper data for replacement from a storage unit, and transmits the wallpaper data for replacement to a wallpaper or theme setting unit; and

S712: the wallpaper or the theme is replaced, that is, the wallpaper or theme setting unit finishes replacing the wallpaper.

By the embodiments and the preferred embodiments, the mobile terminal of the user can autonomously replace the wallpaper, and the diversified application requirements of the user can also be met.

Obviously, those skilled in the art should know that each component or step of the embodiment of the disclosure can be implemented by a universal computing device, and the components or steps can be concentrated on a single computing device or distributed on a network formed by a plurality of computing devices, and can optionally be implemented by programmable codes executable for the computing devices, so that the components or steps can be stored in a storage device for execution with the computing devices, or can form each integrated circuit component, or multiple components or steps therein can form a single integrated circuit component for implementation. As a consequence, the disclosure is not limited to any specific hardware and software combination.

The above is only the preferred embodiment of the disclosure and not intended to limit the disclosure, and for the technician of the field, the disclosure can have various modifications and variations. Any modifications, equivalent replacements, improvements and the like within the spirit and principle of the disclosure shall fail within the scope of protection of the disclosure.

1. A method for processing wallpaper, comprising:
acquiring the position information of a mobile terminal;
judging whether to replace wallpaper displayed by the mobile terminal with a content corresponding to preset position information or not according to the acquired position information and the preset position information; and
displaying the content corresponding to the preset position information as the wallpaper based on that a judgment result is positive.

2. The method according to claim 1, wherein judging whether to replace the wallpaper displayed by the mobile terminal with the content corresponding to the preset position information or not according, to the acquired position information and the preset position information comprises:
acquiring a position coordinate of the mobile terminal and a position coordinate of the content corresponding to the preset position information according to the position information and the preset position information;
judging whether a difference between the position coordinate of the mobile terminal and the position coordinate of the content corresponding to the preset position information is smaller than a preset threshold value or not; and
determining to replace the wallpaper displayed by the mobile terminal with the content corresponding to the preset position information based on that a judgment result is positive.

3. The method according to claim 1, wherein displaying the content corresponding to the preset position information as the wallpaper comprises:
based on that the content corresponding to the preset position information is a photo shot by the mobile terminal, setting a mapping relationship between the shot photo and the acquired position information of the mobile terminal; and
displaying the shot photo corresponding to the acquired position information of the mobile terminal as the wallpaper according to the mapping relationship.

4. The method according to claim 1, before acquiring the position information of the mobile terminal, further comprising:
setting, a preset time interval, and acquiring the position information of the mobile terminal based on that the preset time interval is reached.

5. The method according to claim 4, wherein the position information of the mobile terminal is acquired in at least one of the following manners:
the position information of the mobile terminal is acquired in a Global Positioning System (GPS) positioning manner;
the position information of the mobile terminal is acquired in a Glonass positioning system positioning manner;
the position information of the mobile terminal is acquired in a Wireless Fidelity (Wi-Fi) hotspot positioning, manner; and
the position information of the mobile terminal is acquired in a mobile network cell positioning manner.

6. The method according to claim 4, wherein the content corresponding to the preset position information comprises at least one of:
a picture, an animation, an art text and a series theme.

7. A device for processing wallpaper, comprising:
a first acquiring component, configured to acquire the position information of a mobile terminal;
a first judging component, configured to judge whether to replace wallpaper displayed by the mobile terminal with a content corresponding to preset position information or not according to the acquired position information and the preset position information; and
a first displaying component, configured to display the content corresponding to the preset position information as the wallpaper based on that a judgment result is positive.

8. The device according to claim 7, wherein the first judging component comprises:
a second acquiring component, configured to acquire a position coordinate of the mobile terminal and a position coordinate of the content corresponding to the preset position information according to the position information and the preset position information;
a second judging component, configured to judge whether a difference between the position coordinate of the mobile terminal and the position coordinate of the content corresponding to the preset position information is smaller than a preset threshold value or not; and
a determining component, configured to determine to replace the wallpaper displayed by the mobile terminal with the content corresponding to the preset position information based on that a judgment result is positive.

9. The device according to claim 7, wherein the first displaying component comprises:
a first setting component, configured to, based on that the content corresponding to the preset position information is a photo shot by the mobile terminal, set a mapping relationship between the shot photo and the acquired position information of the mobile terminal; and
a second displaying component, configured to display the shot photo corresponding to the acquired position information of the mobile terminal as the wallpaper according to the mapping relationship.

10. The device according to claim 7, further comprising a second setting component, configured to, before the position information of the mobile terminal is acquired, set a preset time interval, and acquire the position information of the mobile terminal based on that the preset time interval is reached.

11. The method according to claim 2, before acquiring the position information of the mobile terminal, further comprising:
setting a preset time interval, and acquiring the position information of the mobile terminal based on that the preset time interval is reached.

12. The method according to claim 3, before acquiring the position information of the mobile terminal, further comprising:
setting a preset time interval, and acquiring the position information of the mobile terminal based on that the preset time interval is reached.

13. The method according to claim 11, wherein the position information of the mobile terminal is acquired in at least one of the following manners:
the position information of the mobile terminal is acquired in a Global Positioning System (GPS) positioning manner;
the position information of the mobile terminal is acquired in a Glonass positioning system positioning manner;
the position information of the mobile terminal is acquired in a Wireless Fidelity (Wi-Fi) hotspot positioning manner; and
the position information of the mobile terminal is acquired in a mobile network cell positioning manner.

14. The method according to claim 12, wherein the position information of the mobile terminal is acquired in at least one of the following manners:
the position information of the mobile terminal is acquired in a Global Positioning System (GPS) positioning manner;
the position information of the mobile terminal is acquired in a Glonass positioning system positioning manner;
the position information of the mobile terminal is acquired in a Wireless Fidelity (Wi-Fi) hotspot positioning manner; and
the position information of the mobile terminal is acquired in a mobile network cell positioning manner.

15. The method according to claim 11, wherein the content corresponding to the preset position information comprises at least one of:
a picture, an animation, an art text and a series theme.

16. The method according to claim 12, wherein the content corresponding to the preset position information comprises at least one of:
a picture, an animation, an art text and a series theme.

17. The device according to claim 8, further comprising a second setting component, configured to, before the position information of the mobile terminal is acquired, set a preset time interval, and acquire the position information of the mobile terminal based on that the preset time interval is reached.

18. The device according to claim 9, further comprising a second setting component, configured to, before the position information of the mobile terminal is acquired, set a preset time interval, and acquire the position information of the mobile terminal based on that the preset time interval is reached.
